(19) United States
(12) Patent Application Publication
(10) Pub. No.: US 2003/0183049 A1
(43) Pub. Date: Oct. 2, 2003

(54) Hand-held power tool with a holding device

(76) Inventors: Thomas Bader, Landsberg (DE); Thomas Hofbrucker, Mammendorf (DE); Thomas Mahler, Laage (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/397,671

(22) Filed: Mar. 26, 2003

(30) Foreign Application Priority Data
Mar. 28, 2002 (DE) 102 14 310.2

(51) Int. Cl. B25G 1/01

(52) U.S. Cl. 81/489

(57) ABSTRACT

A hand-held power tool including a housing (1) having a handle (7), and a holding device (3) having a catch element (9) and a locking device (11) for releasably securing the catch element (9) to the tool housing (1), with the catch element (g) being secured to the housing (1) in a plane passing through a pivot point (S) and extending parallel to the machine plane defined by the plane of the handle (7) and the operational direction (H) of the tool.

### BACKGROUND OF THE INVENTION

1. Field of the Invention

The present invention relates to a hand-held power tool having a housing with a handle, and at least one holding device having a catch element and a locking device for releasably securing the catch element to the housing.

2. Description of the Prior Art

Hand-held power tools of the type described above include power tools such as screw driving tools, combustion-engined setting tools, drilling tools, chiseling tools, electrically driven saws, and the like. Often, the hand-held tools have a holding device with a catch element for suspending the tool, e.g., from a belt of a user. The free end of the catch element engages, e.g., a belt, which is tightened on a user, with the tool being suspended from the belt and retained under its own belt.

German Publication DE-4233239 discloses, e.g., a hand-held power tool with a housing and a holding device having a catch member. The hook-shaped holding device, which is formed of a steel plate, is elastically deform able and has holding elements engaging corresponding recesses provided in the housing for releasably connecting the holding device with the housing.

A drawback of the known power tool consists in that the suspended tool has no defined position and can pivot into a position in which a user can take hold of, the tool only with much difficulty. In particular in applications in which the user needs one hand for holding an object, this circumstance, i.e., the absence of a definite position of the tool in its suspended position, have very negative repercussions on the handling of the hand-held power tool.

Accordingly, an object of the present invention is to provide a hand held power tool with a holding device which can be economically produced and which, would occupy, in a suspended condition, a definite position.

### SUMMARY OF THE INVENTION

This and other objects of the present invention, which will become apparent hereinafter, are achieved by securing the catch element to the housing in a plane passing through a pivot point of the power tool and extending parallel to the tool plane that is defined by the plane of the handle and the operational direction of the tool.

Because the catch member is secured to the housing in a plane that passes through the pivot point and extends parallel to the power tool plane, pivoting of the power tool, in its suspended condition, outside of the tool plane is prevented. For a tool user, the tool always occupies a predetermined position, ready to be taken hold of. Advantageously, the catch element lies in a plane that divides the power tool so that it would take its predetermined position in case of a necessary pivot ed movement of the power tool.

In order to insure a most possible compact construction of the power tool transverse to th e operational direction of the tool, the catch element advantageously lies, in its fixed to the housing position, within the projection of the housing extending parallel to the operational direction. Further, this insures that the catch element, in its secured to the housing position, does not adversely affect handling of the power tool. Loosening of the catch element from the housing takes a lot of time to correct and, therefore, presents a drawback.

In order to insure that the catch member is secured to the housing at an optimal location, there are provided one or more connection elements on the housing. This insures that dependent on the location of suspension, the catch element is secured to the housing at an optimal location, insuring the best possible handling of the power tool.

Advantageously, the locking device has a pivot position in which the catch element pivots in a plane parallel to the tool plane in order to guarantee an optimal positioning of the power tool in its suspended condition. In particular, in case the power tool is to be suspended on a stationary or at least temporarily stationary object, without a possibility of rotation, it is advantageous to so adapt the pivotal position of the catch element that, on one hand, a user would have an optimal access to the catch element and, on the other hand, the power tool, in particular its operational direction, is optimally aligned. Because the catch element preferably pivots only in one plane parallel to the tool plane, an end position of a suspended tool is clearly defined.

In order to insure a problem-free engagement of the catch element with an object, in particular, with a scaffold, the catch element has a hook-shaped free end.

The free end of the catch element is advantageously provided with bonding element on its inner contour in order to prevent sliding of the catch element about an object the catch element engages or is in contact with. The bonding means can include flutes, rubber coating and the like.

The free end of the catch element is advantageously deformable, which insures an adaptation of the inner contour of the free end at least partially to the outer profile of the object the catch element encompasses, which, in turn, insures a maximal bonding between two parts.

Advantageously, the free end includes several segment sections, with the adjacent sections being hingedly connected with each other. This insures an optimal adaptation of the contact region of the inner contour of the free end to the outer contour of an object the free end engages.

Advantageously, the free end is formed resiliently deformable, which permits to economically produce the catch element.

Advantageously, the free end of the catch element has an inner contour having a, shape of a segment of a cylinder, whereby a catch element an inner contour of the free end of which would optimally adapt to a tubular object, in particular, a scaffold tube, is provided.

The novel features of the present invention, which are considered as characteristic for the invention, are set forth in the appended claims. The invention itself, however both as to its construction and its mode, of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of a hand-held power tool according to the present invention with a mounted holding device in a first location;

FIG. 2 a rear view of the hand-held tool show in FIG. 1;

FIG. 3: a side view of a hand-held power tool according to the present invention with a mounted holding device in a second location;

FIG. 4 a rear view of the hand-held tool show in FIG. 3;

FIG. 5 perspective view of a catch element of the holding device; and

FIG. 6 a side view of the hand-held tool shown in FIG. 3 in a suspended position of the tool.

### DETAILED DESCRIPTION OF THE PREFERRED EMBODIMENT

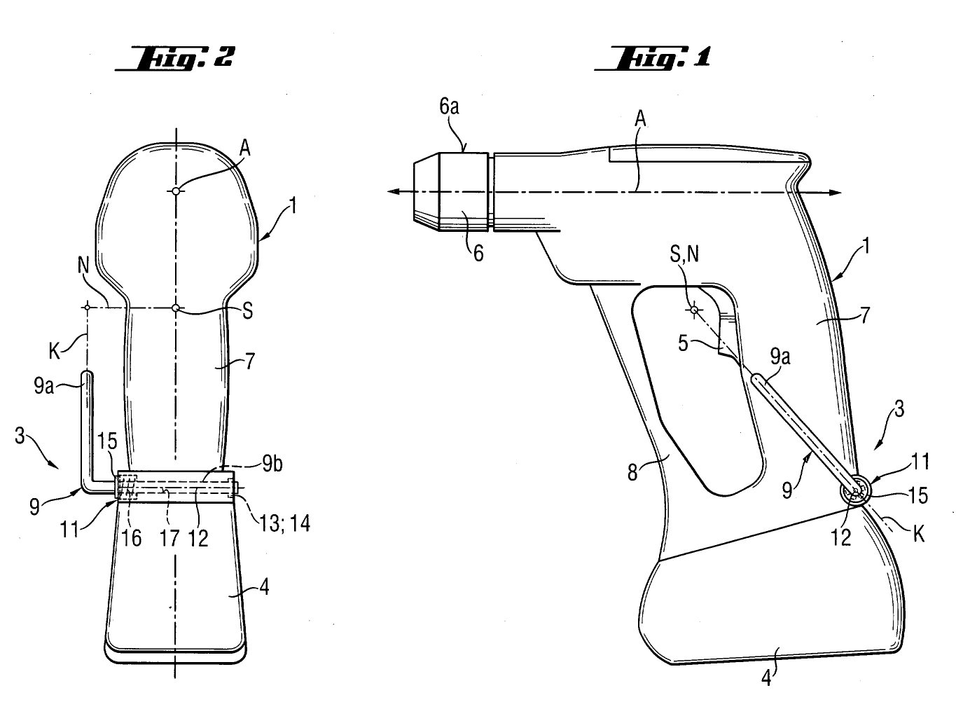

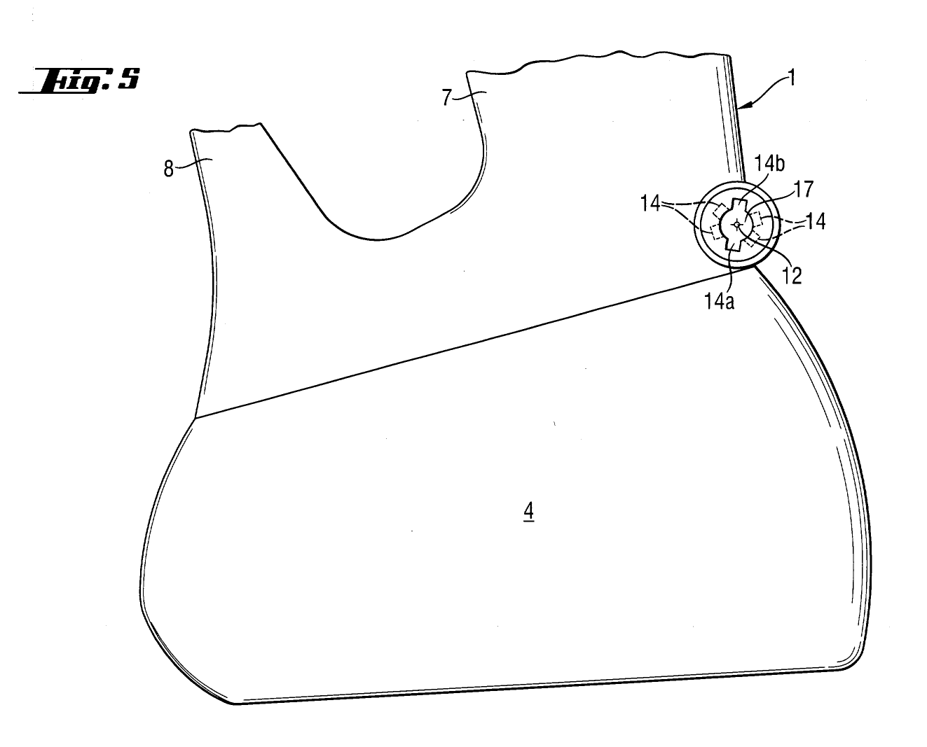

A hand-held power tool according to the present invention, in particular, a screw driving tool, which is shown in FIGS. 1 through 6, has a housing 1 and at least one holding device 3. For guiding the power tool, the housing 1 has a handle 7 at a free end of which, a rechargeable battery 4 for driving the hand-held power tool is provided.

In the housing 1, e.g., an electromotor (not shown), which is powered by the battery 4, is located. The electromotor is operatively connected with a drive shaft. The electromotor is turned on and off with a pressure switch 5 provided on the handle 7. The drive shaft is operatively connected with a chuck 6 adjoining the housing 1. The chuck 6 rotates upon actuation of the electromotor. The chuck 6 has a substantially cylindrical outer contour 6a an axis of which coincides with an operational direction A of the hand-held power tool. The substantially cubic rechargeable battery 4 adjoins a free end of the handle 7 and is releasably connected therewith. A stay member 8 of the handle 7 connects the handle with the housing 1.

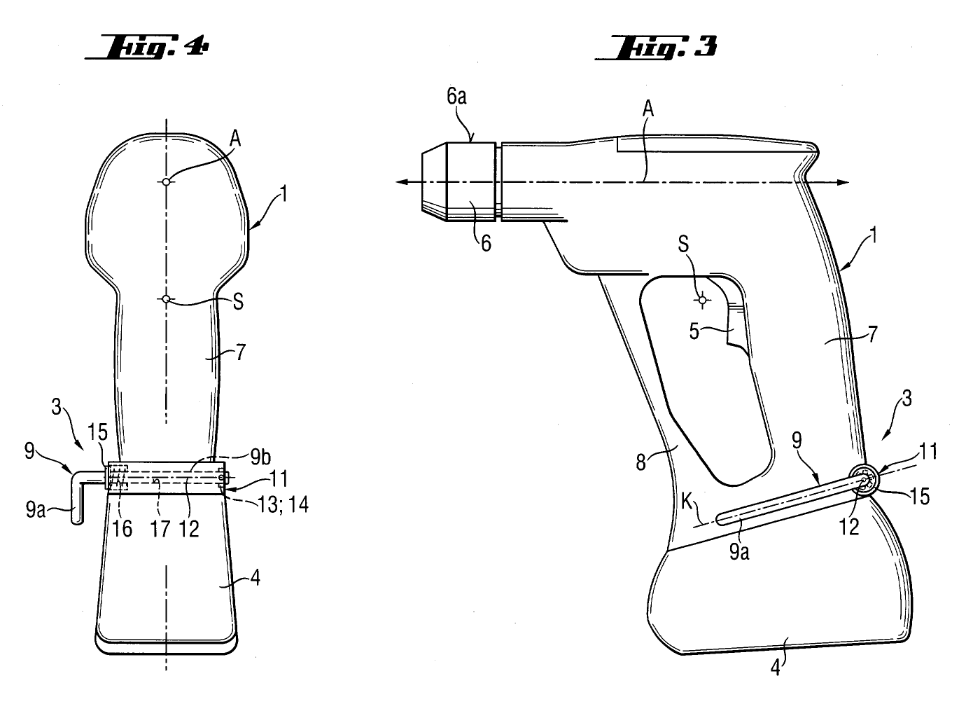

The holding device 3 has a catch element 9 and a locking device 11. The handheld power tool has a tool plane that passes through the operational direction A of the power tool and defines a plane of the handle 7. The catch element 9 is located in a plane P that extends parallel to the tool plane and passes through the center of gravity S. The catch element 9 lies within a projection of the housing 1 that extends parallel to the operational direction A of the power tool. Advantageously, the plane P, which passes through the center of gravity S of, the power tool, is identical with the plane that divides the power tool. On the housing 1, there are provided two connection members 12, 13 at two locations for attaching the locking device 11. A first location, for the connection member 12, is provided at a side of the free end of the handle 7 remote from the operational direction A, in the region of the battery 4, as particularly shown in FIGS. 1-2. A second location, for the connection member 13, is provided in a region of the stay member 8 adjacent to the operational direction A. The second location is provided approximately in the middle of the stay member 8. The two locations provided for suspending the hand-held tool, in its operational direction side region, on an object, or for releasably securing the tool, or for securing or suspending the tool in its opposite region remote from its operational direction side.

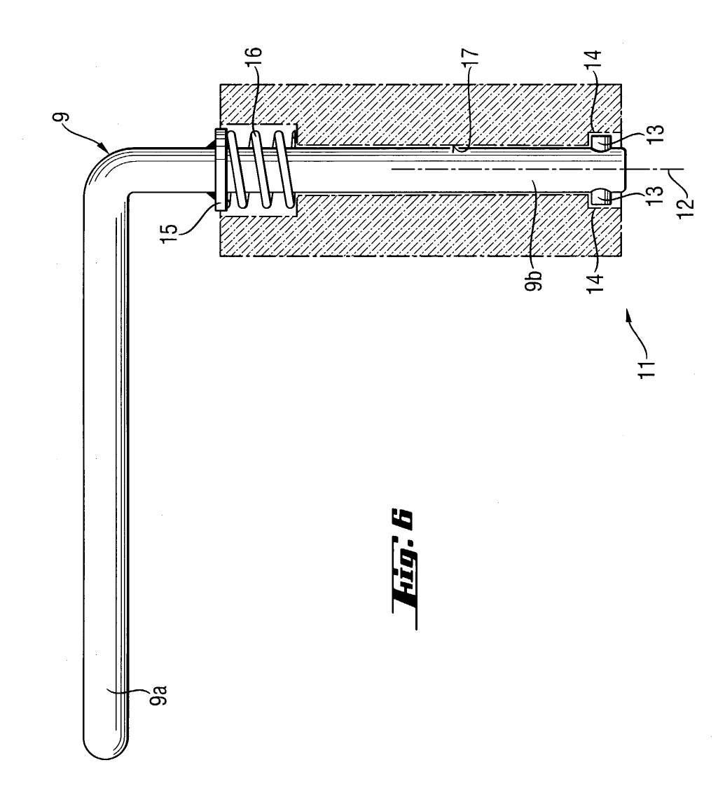

As shown in FIG. 2, the locking device 11 has a stationary position and a pivot position (shown in dash lines),in which the catch element 9 pivots in the plane P that extends parallel to the tool plane. In the stationary position of the locking device, the catch member 9 is fixedly secured with respect to the housing, without a possibility of a pivotal movement. The hook-shaped catch element 9 has a free end 9a provided on its inner contour 14, with bonding means, in particular, with ribs 15 extending transverse to the catch member 9 and having a semi-cylindrical cross-section. In addition, the free end 9a is formed as a deformable section, in particularly, resiliently deformable. Alternatively, the free and 9a can be formed of a plurality of segment sections, with the adjacent segment sections being hingedly connected with each other. The inner contour 14 of the free end 9a can have, e.g., a shape of a cylindrical segment. The catch element 9 is shown separately at an increased scale, in FIG. 5. The catch element 9 has a cylindrical connection section 9b for releasably connecting the catch member 9 to the housing 1 of the power tool. The connection section 9b extends transverse to the longitudinal extent of the catch element 9 and adjoins the free end 9a of the catch element 9. The connection section 9 has a through-bore 17 likewise extending transverse to the longitudinal extent of the catch element 9. The catch element 9 is connected with the housing 1 of the power tool by the locking device 11 and one of the connection members 12, 13. The connection section 9b of the catch element 9 has, in addition, catch means 16 which are provided on the outer contour of the connection section 9b and which cooperate with complimentary catch means (not shown) provided on the housing 1. Thereby, the catch element 9 can be releasably connected with the housing 1 in a plurality of pivot positions by the locking device 11.

FIG. 6 shows a hand-held power tool suspended on a first tube 20, e.g., a scaffold tube. A second tube 21 serves as a stop that cooperates with the battery 4 to prevent a pivotal movement of the tool about a suspension point B. The inner contour 14 of the elastic free and 9a of the catch element 9 is optimally adapted to the outer contour of a fixed object, i.e., the first tube 20. Dependent from an application field, the inner contour of the free end of a catch member can have a geometry different from that shown in the drawings. E.g., the free end of the catch element can have a rectangular cross-section. The second tube 21, which functions as a stop, can also serve, temporarily, as an object e.g., as part of a wall, automobile. Further, other parts of the power tool can cooperate with the tube 21, e.g., housing 1, chuck 6, etc.

Though the present invention was shown and described with references to the preferred embodiment, such is merely illustrative of the present invention and is not to be construed as a limitation thereof, and various modifications to the present invention will be apparent to those skilled in the art. It is, therefore, not intended that the present invention be limited to the disclosed embodiment or details thereof, and the present invention includes all of variations and/or alternative embodiments within the spirit and scope of the present invention as defined by the appended claims.

What is claimed is:

1. A hand-held power tool, comprising a housing (1) having a handle (7), with a plane of the handle (7) defining, together with an operational direction (A) of the tool, a tool plane; and a holding device (3) having a catch element (9), and a locking device (11) for releasably securing the catch element (9) to the tool housing (1), with the catch element (9) being secured to the housing (1) in a plane (P) passing through a pivot point (S) of the power tool and extending parallel to the machine plane.

2. A hand-held power tool according to claim 1, wherein the catch element (9) is located, in its, secured to the housing position, within a projection of the housing (1) extending parallel to the operational direction (A).

3. A hand-held power tool according to claim 1 wherein connection means (12, 13) for securing the catch element (9) to the housing (1) is provided at at least one location on the housing (1).

4. A hand-held power tool according to claim 1, wherein the locking device (1) has a position in which the catch element (9) pivots in a plane parallel to the tool plane.

5. A hand-held power tool according to claim 1, wherein the catch element (9) has a hook-shaped free end (9a).

6. A hand-held power tool according to claim 5, wherein the free end (9a) has an inner contour (14) provided with bonding means (15).

7. A hand-held power tool according to claim 5, wherein the free end (9a) is deformable.

8. A hand-held power tool according to claim 5, wherein the free end (9a) comprises a plurality of segments hingedly connected with each other.

9. A hand-held power tool according to claim 7, wherein the free end (9a) is elastically deformable.

10. A hand-held power tool according to claim 5, wherein the free end (9a) has an inner contour (14) having a shape of a cylindrical segment.

11. A holding device for a hand-held power tool including a housing (1) having a handle (7), with a plane of the handle (7) defining, together with an operational direction (A) of the tool, a tool plane, the holding device (3) comprising a catch element (9), and a locking device (11) for releasably, securing the catch element (9) to the tool housing (1), with the catch element (g) being secured to the housing (1) in a place (P) passing through a pivot point (S) and extending parallel to the machine plane.
